(19) United States
(12) Patent Application Publication
(10) Pub. No.: US 2024/0205979 A1
(43) Pub. Date: Jun. 20, 2024

(54) TECHNIQUES FOR ASSOCIATION BASED OPTIMIZATIONS IN SIDELINK SYSTEMS

(71) Applicant: QUALCOMM Incorporated, San Diego, CA (US)

(72) Inventors: Anantharaman BALASUBRAMANIAN, San Diego, CA (US); Shuanshuan Wu, San Diego, CA (US); Mohit Narula, San Diego, CA (US)

(21) Appl. No.: 18/069,079

(22) Filed: Dec. 20, 2022

(51) Int. Cl. H04W 74/08; H04W 72/40

(52) U.S. Cl. CPC H04W 74/0833; H04W 72/40

(57) ABSTRACT

Aspects of the present disclosure leverage the association of the multiple user equipments (UEs) in order to minimize the need for separate random access channel (RACH) procedures and beam management procedure for each UE within the group, and in turn minimize network congestion and probability of traffic collisions.

### BACKGROUND

### Technical Field

The present disclosure relates generally to communication systems, and more particularly, to techniques for association based optimizations in sidelink systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5GNR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one example, a method for wireless communication is disclosed. The method may include receiving, at a first user equipment (UE), a configuration message from a network entity that assigns a unique random access channel (RACH) sequence for the first UE to access a channel for communication with the network entity. In some aspects, the first UE may be grouped with at least one second UE. The method may further include transmitting, from the first UE to the at least one second UE, scheduling information that indicates one or more time slots for the at least one second UE to access the channel for communication with the network entity utilizing the unique RACH sequence that the network entity assigned to the first UE. In some examples, the unique RACH sequence may be shared between the first UE and the at least one second UE for non-contention based access to the channel.

In another example, an apparatus for wireless communication is disclosed. The apparatus may include a memory storing computer-executable instructions and at least one processor coupled with the memory and configured to execute the computer-executable instructions to receive, at a first UE, a configuration message from a network entity that assigns a unique RACH sequence for the first UE to access a channel for communication with the network entity. In some aspects, the first UE may be grouped with at least one second UE. The computer-executable instructions may further be configured to transmit, from the first UE to the at least one second UE, scheduling information that indicates one or more time slots for the at least one second UE to access the channel for communication with the network entity utilizing the unique RACH sequence that the network entity assigned to the first UE. In some examples, the unique RACH sequence may be shared between the first UE and the at least one second UE for non-contention based access to the channel.

In one example, the method for wireless communications is disclosed. The method may include receiving, at a first UE, at least a portion of results from a beam search operation conducted between a second UE and a network entity, wherein the first UE is associated with the second UE. The method may further include initiating a random access channel (RACH) procedure between the first UE and the network entity based on the at least portion of the results from the beam search operation received from the second UE.

another example, an apparatus for wireless communication is disclosed. The apparatus may include a memory storing computer-executable instructions and at least one processor coupled with the memory and configured to execute the computer-executable instructions to receive, at a first UE, at least a portion of results from a beam search operation conducted between a second UE and a network entity, wherein the first UE is associated with the second UE. The computer-executable instructions may further be configured to initiate a random access channel (RACH) procedure between the first UE and the network entity based on the at least portion of the results from the beam search operation received from the second UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first 5G NR frame.

FIG. 2B is a diagram illustrating an example of DL channels within a 5G NR subframe.

FIG. 2C is a diagram illustrating an example of a second 5G NR frame.

FIG. 2D is a diagram illustrating an example of a 5G NR subframe.

FIG. 3 is a diagram illustrating an example of a base station and user equipment (UE) in an access network.

FIG. 4 is a diagram illustrating an example message exchange for a 4-step random access procedure between a base station and a UE in an access network.

FIG. 5 is a diagram illustrating an example message exchange for a 2-step random access procedure between a base station and a UE in an access network.

FIG. 6A is an example of a beam search operation between a base station and a UE in accordance with an aspect of the present disclosure.

FIG. 6B is another example of a beam search operation between a base station and a UE in accordance with an aspect of the present disclosure.

FIG. 6C is another example of a beam search operation between a base station and a UE in accordance with an aspect of the present disclosure.

FIG. 7A is one example scenario where multiple UEs may be associated with one another in accordance with aspects of the present disclosure.

FIG. 7B is another example scenario where multiple UEs may be associated with one another in accordance with aspects of the present disclosure.

FIG. 8 is a conceptual call flow diagram illustrating the data flow between UEs that are associated with each other and the network entity.

FIG. 9 is another conceptual call flow diagram illustrating the data flow between UEs that are associated with each other and the network entity.

FIG. 10 is a schematic diagram of example components of UE.

FIG. 11 is a flowchart of a method of wireless communication performed by a UE.

FIG. 12 is another flowchart of a method of wireless communication performed by a UE.

FIG. 13 is a schematic diagram of example components of network entity.

### DETAILED DESCRIPTION

A random-access channel (RACH) is channel that may be shared by multiple user equipments (UEs) and may be used by the UEs to access the network for communications. For example, the RACH may be used for call setup and/or to access the network for data transmissions. In some cases, RACH may be used for initial access to a network when a user equipment (UE) switches from an idle mode to a radio resource control (RRC) connected active mode, or when performing handover to a target cell in RRC connected mode. Moreover, RACH may be used for downlink (DL) and/or uplink (UL) data when the UE is in RRC idle or RRC inactive modes, and when reestablishing a connection with the network.

A two-step RACH reduces latency for initial access compared to the conventional four-step RACH by avoiding the additional messaging round trips (e.g., by transmitting the random access preamble and data in a single message as opposed to separate transmissions). The two-step RACH is especially advantageous when unlicensed channel access is considered as it avoids the additional look-before-transmission (LBT) procedures that are typically incurred in a four-step RACH to access the channel multiple times.

There may be two types of channel access: (1) contention based channel access and (2) non-contention based channel access. The contention based channel access may include a method where a UE chooses RACH sequence randomly from a codebook and transmits to the network entity (e.g., base station). In some scenarios, multiple UEs may also choose the same sequence resulting in a collision, and therefore the UEs may incur delays in accessing the channel. In non-contention based channel access, the network entity may assign a preconfigured sequence for a UE to access the channel. As the network entity assigns a distinct sequence to the UE, the probability of traffic collision may be eliminated. Additionally or alternatively, the network entity and the UEs may perform beam search operation to establish communication. The beam search operation may refer to the process by which the network entity and the UE jointly decide on the appropriate transmit/receive beam for communication.

But in some instances, for example, when multiple UEs are associated or in close proximity to each other (e.g., multiple UEs located within the same vehicle or a first UE such as a smartphone that is associated with a second UE such as a smart watch or another peripheral), each UE may access the network independently by initiating separate RACH procedures and beam search operation. Such independent procedures initiated by each UE may be inefficient and waste resources since each independent network access and beam search operation may require separate signal messaging between the UEs and the network entities. Aspects of the present disclosure leverage the association of the multiple UEs that may be in communication via sidelink in order to minimize the need for separate RACH procedures for each UE, and in turn minimize network congestion and probability of traffic collisions.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. The computer-readable media may be referred to as a non-transitory computer readable medium. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

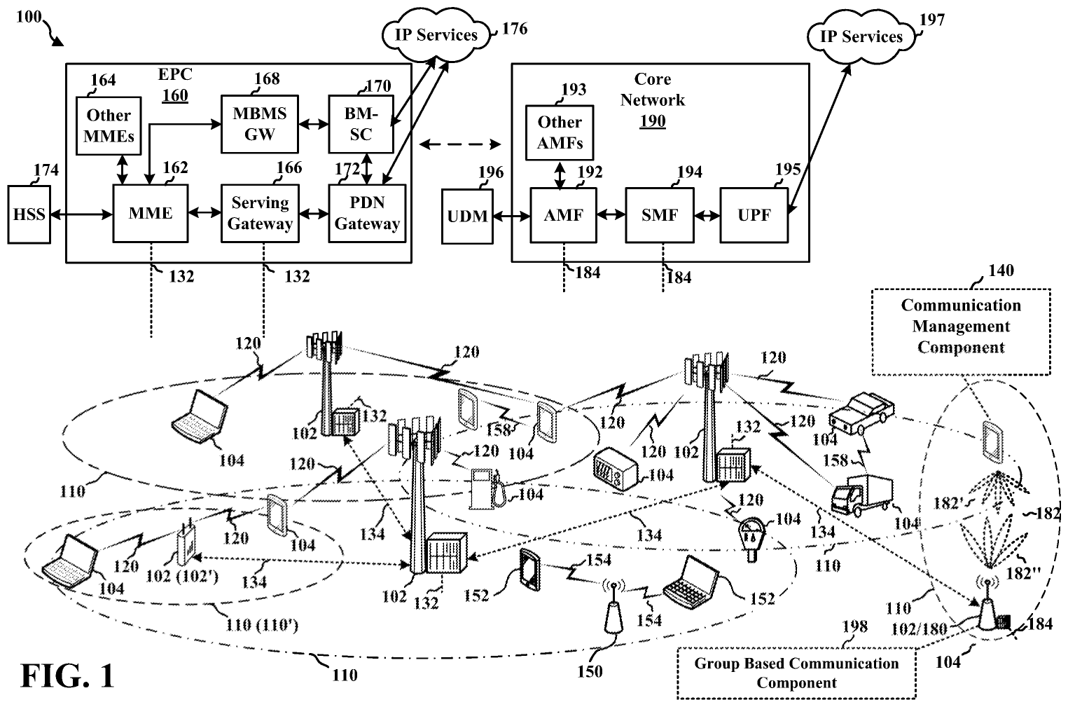

FIG. 1 is a diagram illustrating an example of a wireless communications system and an access network 100. The wireless communications system (also referred to as a wireless wide area network (WWAN)) includes base stations 102 (or network entities), UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

In certain aspects, the UE 104 may include a communication management component 140 configured to allow for a plurality of UEs that are associated or grouped together to access the channel for communications with the base stations 102/180 without each UE separately requiring RACH or beam search operation. As discussed in more detail below, in some examples, the communication management component 140 may receive a non-contention RACH sequence that may be shared amongst a plurality of UEs for access to the channel. In other examples, communication management component 140 may allow a single UE (e.g., master UE) from the plurality of UEs 104 to perform a beam search operation with the base station such that the remaining UEs may circumvent or omit performing one or more beam management steps in order to conserve resources. In some examples, the UEs within the group may be part of a reduced capability (RedCap) devices and/or IoT devices used for several scenarios including wearable devices, industrial wireless sensors, and video surveillance. Some of these scenarios may involve stationary devices. There may be a relatively large number of such devices located within a cell. More particularly, a large number of such devices may share a transmit beam of the cell. For instance, multiple devices located in close proximity may select the same SSB as the strongest transmit beam. For example, in one use case, co-located cameras or industrial sensors may be scheduled to upload data to the network at a specific time. As another example, a parking facility for personal vehicles such as bicycles or scooters may include numerous devices that attempt to access the network at particular times (e.g., rush hour).

Additionally, one or more base stations 102/180 may include a group based communication component 198 that communicates with the plurality of UEs 104 that are associated or grouped together and coordinates access to the channel for the group. The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies.

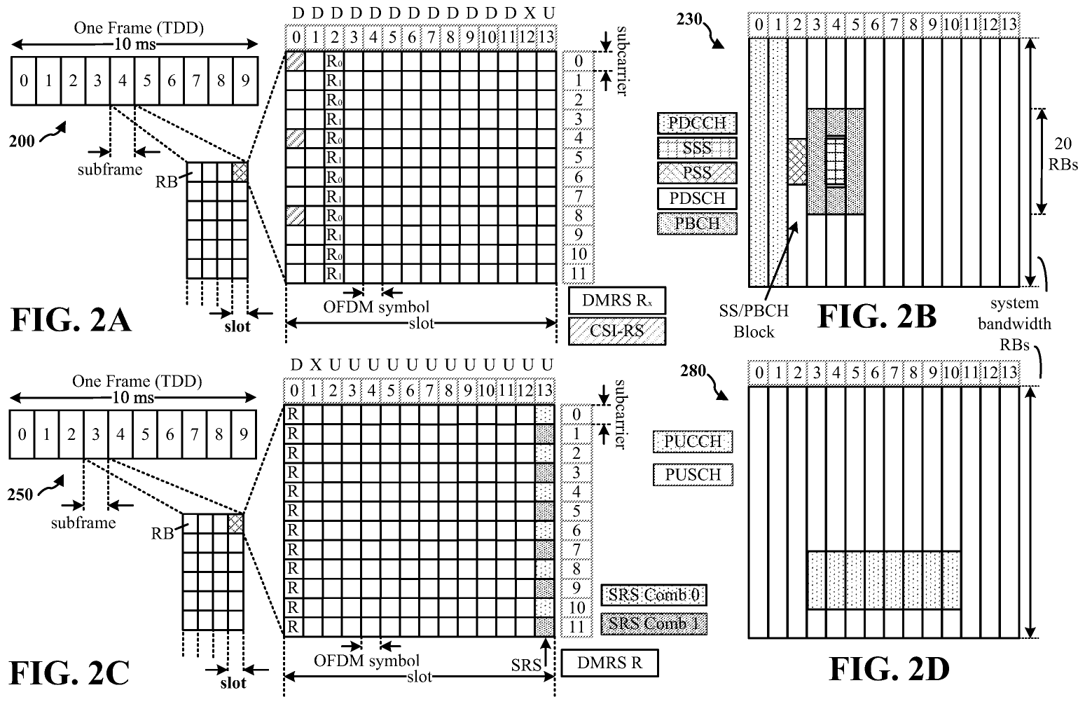

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2^{μ} slots/subframe. The subcarrier spacing and symbol length/duration are a function of the numerology. The subcarrier spacing may be equal to 2^{μ}*15 kHz, where y is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

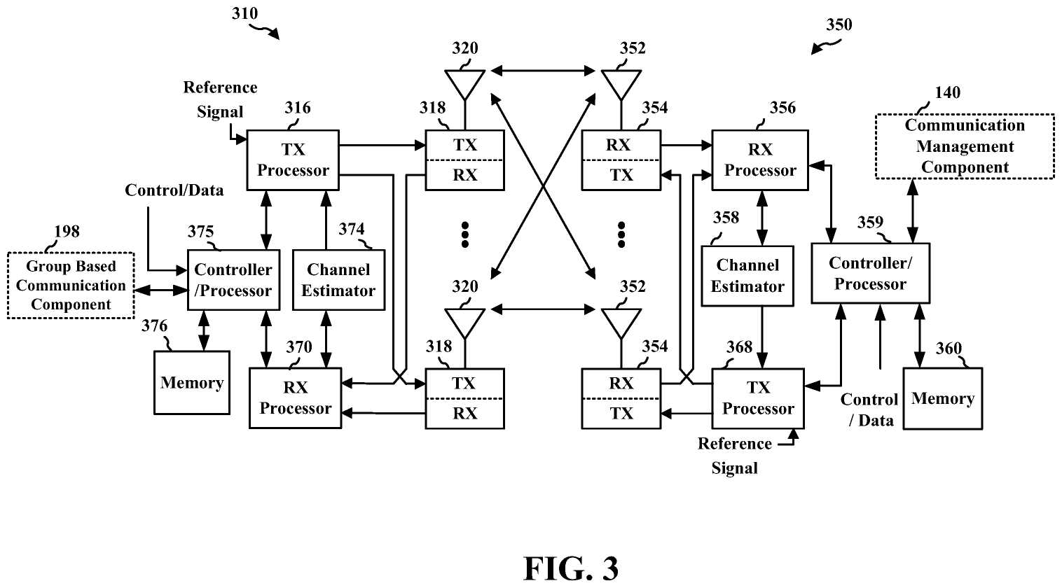

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be coupled with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be coupled with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the communication management component 140 of FIG. 1.

At least one of the TX processor 316, the RX processor 370, and the controller/processor 375 may be configured to perform aspects in connection with the group based communication component 198 of FIG. 1.

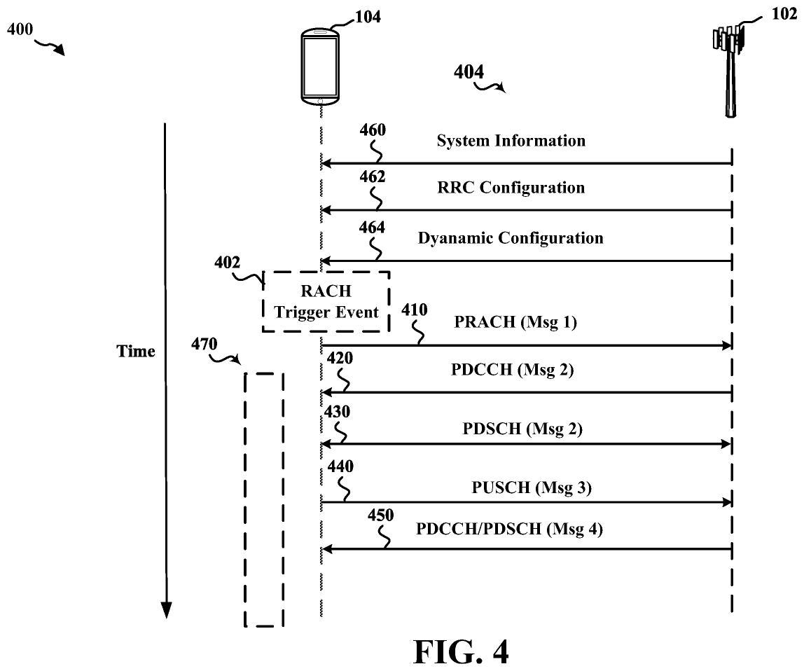

FIG. 4 is a diagram 400 illustrating an example message exchange for a 4-step RACH procedure 404 between a base station 102 and a UE 104 in an access network. The UE 104 may be configured to perform the RACH procedure 404 based on a physical RACH (PRACH) configuration. For example, the base station 102 may transmit system information 460 including a first PRACH configuration. The system information 460 may be applicable to any UE attempting to connect to the base station 102, including UEs in an idle state.

In some implementations, the system information 460 may include a second PRACH configuration. For example, the system information 460 may include a second set of PRACH parameters that may be dynamically activated. For instance, the base station 102 may transmit the dynamic configuration message 464 to activate the second PRACH configuration. In other implementations, the second PRACH configuration may follow a pattern. For example, the pattern may specify specific times of day when the second PRACH configuration is to be followed. For instance, the pattern may indicate that the second PRACH configuration is to be used at certain busy times of day such as a rush hour at the close of business. The busy times may be determined based on a record of RACH procedures performed.

In some implementations, the base station 102 may transmit an RRC configuration 462 including one or more PRACH configuration parameters. For example, the base station 102 may transmit the RRC configuration 462 to set PRACH parameters for a particular UE. The RRC configuration 462 may be a higher layer (e.g., layer 3) message carried on a PDSCH. Accordingly, a UE 104 may need to be in a connected mode to receive the RRC configuration 462.

In some implementations, the base station 102 may transmit a dynamic configuration message 464. The dynamic configuration message 464 may be referred to as a non-RRC message. The dynamic configuration message 464 may be transmitted as a downlink control information (DCI), media access control (MAC) control element (CE), or a paging message. The dynamic configuration message 464 may include a PRACH configuration update that indicates one or more parameters of the second PRACH configuration.

The second PRACH configuration may include one or more of: a number of RACH occasions in a frequency domain, a PRACH configuration index, a number of random access preambles, a number of contention-based preambles, or a number of SSBs per RACH occasion. The number of RACH occasions in the frequency domain may define the frequency domain resources for the PRACH. The PRACH Configuration Index (e.g., a prachConfIndex parameter) may specify an index that informs the UE of which frame number and which subframe number within the frame includes PRACH resources. That is, the PRACH Configuration Index may define time domain resources for the PRACH. The number of random access preambles may be a number of preambles from which the UE may select. The number of contention-based preambles may define a subset of the number of preambles to be used for contention-based random access. The number of SSBs per RACH occasion may define which RACH occasion a UE is to use based on a selected SSB.

Referring additionally to Table 1 (below), during operation, UE 104 may execute an implementation of an NR RACH procedure 404, according to a 4-step NR RACH message flow, due to the occurrence of one or more RACH trigger events 402. Suitable examples of RACH trigger events 402 may include, but are not limited to: (i) the UE 104 performing an initial access to transition from an RRC_IDLE state to RRC_CONNECTED ACTIVE state; (ii) the UE 104 detecting downlink (DL) data arrival during while in an RRC_IDLE state or RRC_CONNECTED INACTIVE state; (iii) the UE 104 determining UL data arrival from higher layers during RRC_IDLE state or RRC_CONNECTED INACTIVE state; (iv) the UE 104 performing a handover from another station to the base station 102 during the connected mode of operation; and (v) the UE performing a connection re-establishment procedure such as a beam failure recovery procedure.

The NR RACH procedure 404 may be associated with a contention based random access procedure, or with a contention free random access procedure. In an implementation, a contention based NR RACH procedure corresponds to the following RACH trigger events 402: an initial access from RRC_IDLE to RRC_CONNECTED ACTIVE; UL data arrival during RRC_IDLE or RRC_CONNECTED INACTIVE; and a connection re-establishment. In an implementation, a contention-free NR RACH procedure corresponds to the following RACH trigger events 402: downlink (DL) data arrival during RRC_IDLE or RRC_CONNECTED INACTIVE; and, a handover during the connected mode of operation.

On the occurrence of any of the above RACH trigger events 402, the execution of the NR RACH procedure 404 may include the 4-step NR RACH message flow (see FIG. 4 and Table 1), where UE 104 exchanges messages with one or more base stations 102 to gain access to a wireless network and establish a communication connection. The messages may be referred to as random access messages 1 to 4, RACH messages 1 to 4, or may alternatively be referred to by the PHY channel carrying the message, for example, message 3 PUSCH.

TABLE 1
NR RACH procedure, including Messages and Message Content
transmitted over corresponding Physical (PHY) channel(s).

| PHY Channel | Message | Message content |
|---|---|---|
| PRACH | Msg1 | RACH Preamble |
| PDCCH/PDSCH | Msg2 | Detected RACH preamble ID, TA, TC- |
| | | RNTI, backoff indicator, UL/DL grants |
| PUSCH | Msg3 | RRC Connection request (or scheduling |
| | | request and tracking area update) |
| PDCCH/PDSCH | Msg4 | Contention resolution message |

In a first step of a first RACH procedure, for example, UE 104 may transmit a first message (Msg1) 410, which may be referred to as a random access request message, to one or more base stations 102 via a physical channel, such as a physical random access channel (PRACH). For example, Msg1 may include one or more of a RACH preamble and a resource requirement. The UE 104 may transmit the Msg1 on a random access occasion (RO). In an aspect, the RACH preamble may be a relatively long preamble sequence, which may be easier for the base station 102 to receive than an OFDM symbol.

In a second step of the RACH procedure, the base station 102 may respond to Msg1 by transmitting a second message (Msg2), which may be referred to as a random access response (RAR) message. The RAR message may include a physical downlink control channel (PDCCH) 420 and a physical downlink shared channel (PDSCH) 430. In an aspect, the UE random access component 140 may monitor the PDCCH during a first RAR window 470 based on the first Msg1 410 to detect a PDCCH 420 of the first RAR message as a DCI format 1_0 with a CRC scrambled by a RA-RNTI corresponding to the first Msg1 410 and receive the PDSCH 430 of the RAR message as a transport block in a corresponding PDSCH within the RAR window 470.

The UE 104 may receive a transport block in a corresponding PDSCH indicated by a successfully decoded PDCCH 420. The UE 104 may decode transport block and parse the transport block for a random access preamble identity (RAPID) associated with the Msg1. For example, Msg2 may include one or more of a detected preamble identifier (ID), a timing advance (TA) value, a temporary cell radio network temporary identifier (TC-RNTI), a backoff indicator, an UL grant, and a DL grant. If the UE 104 identifies a RAPID corresponding to the Msg1 410 in the transport block, the UE 104 may identify a corresponding UL grant for Msg3. This is referred to as RAR UL grant in the physical layer.

In response to receiving Msg2, UE 104 transmits to the base station 102 a third message (Msg3) 440, which may be a RRC connection request or a scheduling request, via a physical uplink channel such as PUSCH based on the RAR UL grant provided in Msg2 of a selected serving base station 102.

In response to receiving Msg3 440, base station 102 may transmit a fourth message (Msg4) 450, which may be referred to as a contention resolution message, to UE 104 via a PDCCH and a PDSCH. For example, Msg4 may include a cell radio network temporary identifier (C-RNTI) for UE 104 to use in subsequent communications.

In some example scenarios, a collision between two or more UEs 104 requesting access can occur. For instance, two or more UEs 104 may send Msg1 having a same RACH preamble because the number of RACH preambles may be limited and may be randomly selected by each UE 104 in a contention-based NR RACH procedure. As such, each colliding UE 104 that selects the same RACH preamble will receive the same temporary C-RNTI and the same UL grant, and thus each UE 104 may send a similar Msg3. In this case, base station 102 may resolve the collision in one or more ways. In a first scenario, a respective Msg3 from each colliding UE 104 may interfere with the other Msg3, so base station 102 may not send Msg4. Then each UE 104 will retransmit Msg1 with a different RACH preamble. In a second scenario, base station 102 may successfully decode only one Msg3 and send an ACK message to the UE 104 corresponding to the successfully decoded Msg3. In a third scenario, base station 102 may successfully decode the Msg3 from each colliding UE 104, and then send a Msg4 having a contention resolution identifier (such as an identifier tied to one of the UEs) to each of the colliding UEs. Each colliding UE 104 receives the Msg4, decodes the Msg4, and determines if the UE 104 is the correct UE by successfully matching or identifying the contention resolution identifier. Such a problem may not occur in a contention-free NR RACH procedure, as in that case, base station 102 may inform UE 104 of which RACH preamble to use.

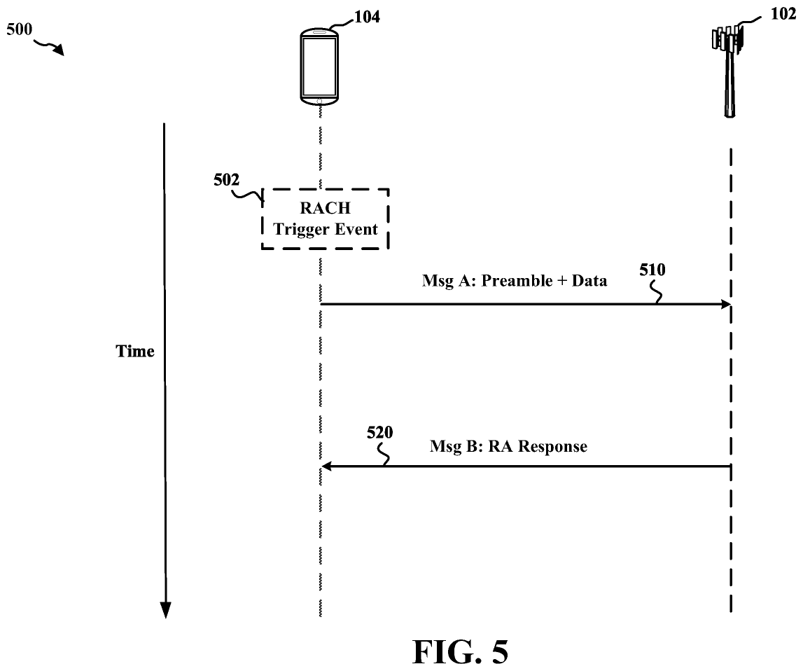

FIG. 5 is a diagram 500 illustrating an example message exchange for a 2-step RACH procedure between a base station 102 and a UE 104 in an access network. In a two-step RACH procedure, the UE initiates a RACH trigger event 502 (e.g., initiate network access) and transmits both RACH preamble and payload to a base station (e.g., a gNB) within message “A” 510 before receiving a random access response from the gNB. As an example, a 2-step RACH for NR may have design objectives that include: 2-step RACH shall be able to operate regardless of whether the UE has a valid timing advance (TA) or not. The 2-step RACH is applicable to any cell size supported in Rel-15 NR. In 2-step RACH, multiple messages in the 4-step RACH procedure may be combined in a single message. More specifically, MsgA 510 combines Msg1 and Msg3 and MsgB 520 combines Msg2 and Msg4. The MsgA 510 may include preamble and PUSCH carrying payload where the content of MsgA 510 includes the equivalent contents of Msg3 of 4-step RACH. The content of MsgB 520 includes the equivalent contents of Msg2 and Msg4 of 4-step RACH. In an aspect, a second PRACH configuration may be dynamically selected for the 2-step RACH procedure. For example, the second PRACH configuration may be selected when an increased number of RACH procedures is expected.

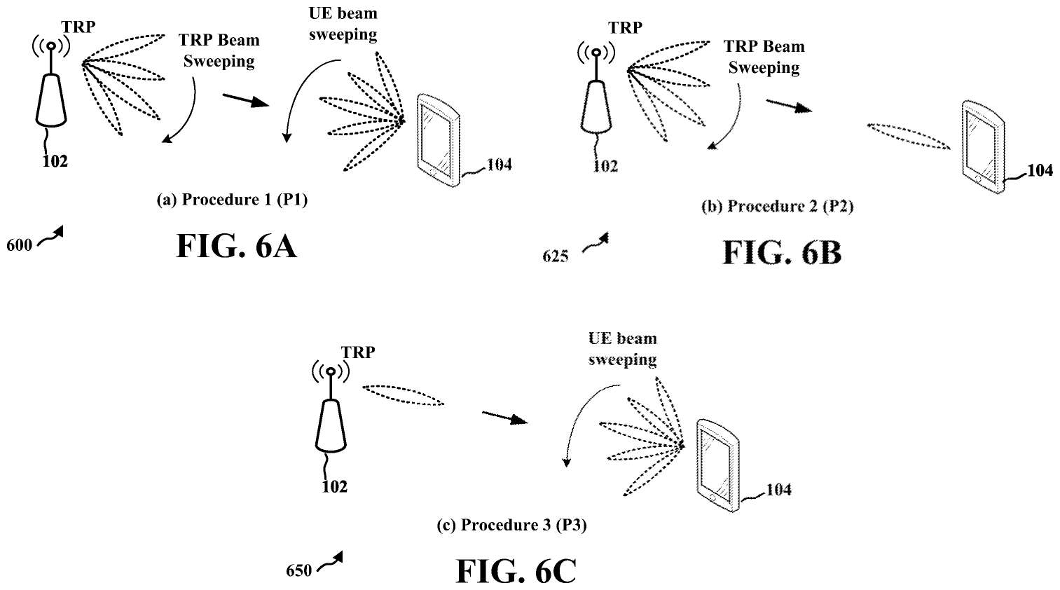

The network entities 102 and UE 104 may conduct beam search operations in order to select an appropriate beam for communication. FIGS. 6A-6C are an example of a beam search operation between a network entity such as a gNB 102 and a UE 104. A beam search operation may be a process by which the gNB 102 and the UE 104 may jointly decide on the appropriate transmit/receive beams for communications. FIG. 6A illustrates a first step of the procedure (P1), FIG. 6B illustrates the second step of the procedure (P2), and FIG. 6C illustrates the third step of the procedure (P3) of the beam search operation in accordance with one example.

As illustrated in FIG. 6A, step P1 600 may be used to enable UE measurement on different transmission reception points (TRPs) transmitter (Tx) beams to support selection of TRP Tx beams/UE receiver (Rx) beam(s). For beamforming at TRP 102, the gNB 102 may perform an intra/inter-TRP Tx beam sweep from a set of different beams. And for beamforming at UE 104, the UE 104 may perform UE Rx beam sweep from a set of different beams. Step P2 625, as illustrated in FIG. 6B, enables the UE 104 measurement on different TRP Tx beams to possibly change inter/intra-TRP Tx beam(s). From a possibility smaller set of beams for different beam refinements than in step P1. And step P3 650, as illustrated in FIG. 6C, enables UE measurement on the same TRP Tx beam to change UE Rx beam in case UE uses beamforming.

And as noted above, in some instances, even when multiple UEs 104 are associated or in close proximity to each other, each UE 104 may access the network independently by initiating separate RACH procedures and beam search operations. Such independent procedures initiated by each UE 104 may be inefficient and waste resources since each independent network access and beam search operation may require separate signal messaging between the UEs 104 and the network entities. Aspects of the present disclosure leverage the association of the multiple UEs 104 that may be in communication via sidelink in order to minimize the need for separate RACH procedures for each UE, and in turn minimize network congestion and probability of traffic collisions.

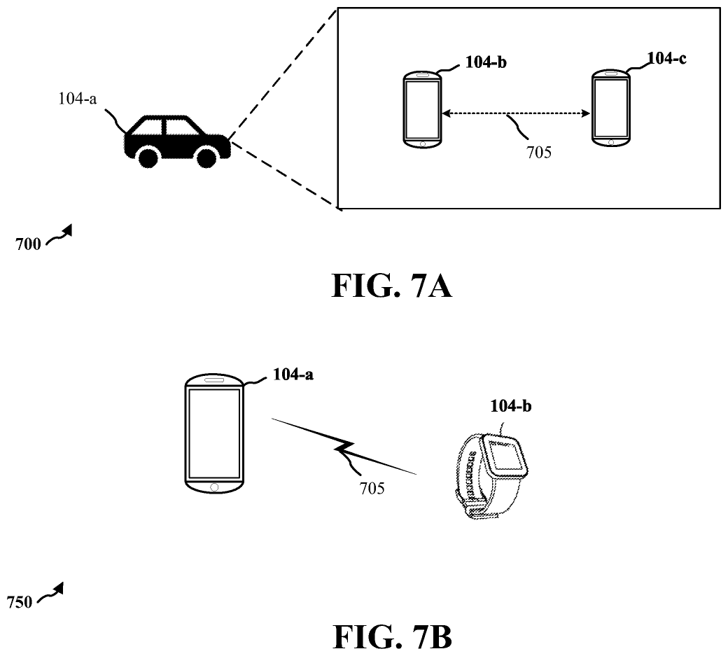

FIG. 7A is diagram 700 of one example scenario where multiple UEs 104 may be associated or grouped with one another. For purposes of the present disclosure, the term “associated” or “grouped” may refer to a first UE that is either connected to, correlate to, or shares a characteristic with at least one additional UE (e.g., a second UE). For example, as illustrated in FIG. 7A, a vehicle UE 104-a (e.g., first UE 104-a) may include one or more passenger UEs (e.g., second UE 104-b and third UE 104-c). In such instance, the multiple UEs 104 may share a common characteristic to the extent that the UEs 104 may be located within the same vehicle or may be in close proximity and/or traveling together. Although the illustrated example shows a vehicle UE 104-a that includes a plurality of passenger UEs (104-b, 104-c) within the same vehicle, it should be appreciated that UEs 104 that are in a vehicle (e.g., a train) but different carts, or different vehicles but traveling adjacent to one another may also be considered “associated” with each other in the context of the present disclosure.

Another example scenario is illustrated in FIG. 7B that shows diagram 750 where a first UE 104-a may be associated with a peripheral UE 104-b (e.g., RedCap devices and/or IoT devices that may be used for several scenarios including wearable devices, industrial wireless sensors, and video surveillance). In such instance, the first UE 104-a may be associated with the second UE 104-b via sidelink 705 communication. It should be appreciated by those of ordinary skill that FIGS. 7A and 7B are non-limiting example scenarios for implementations of the techniques of the present disclosure and the techniques provided here may be utilized in other scenarios.

Aspects of the present disclosure leverage the association of a plurality of UEs (e.g., UEs that are grouped together) to optimize the performance of each of the one or more UEs within the group for one or both of RACH and/or beam management procedures. The features of the present disclosure provide a number of advantages over traditional techniques. For example, in accordance with techniques disclosed herein, multiple UEs that are grouped or associated together can share a sequence for non-contention based network access. The sharing of the sequence for non-contention based network access allows for reduction in access delay for the UEs within the group. In addition, the plurality of UEs may coordinate through sidelink as to which UEs may access the channel at any particular time, thereby allowing other UEs in the group to refrain from performing channel access using the same sequence during the same period.

To implement such techniques, a “master UE” 104 from the plurality of UEs 104 that are associated or grouped together may be selected or designated. For example, with reference to FIGS. 7A and 7B, the first UEs 104-a may be selected or designated as the “master UE” while the one or both of the second UE 104-b and third UE 104-c may be referred to as “slave UEs.” The selection and designation of which UE serves as the master may be based on the capabilities of UE that are resolved by the plurality of UEs or assigned by the network entity.

Once a “master UE” 104 is designated or selected from the plurality of UEs that are grouped together, the network entity may configure a non-contention RACH sequence to the master UE 104 to access the channel for communications with the network entity. The unique RACH sequence for the master UE to access the channel may then be utilized by one or more of the plurality of UEs 104 within the group. For example, with reference to FIG. 7A, the network entity may configure the first UE 104-a (e.g., vehicle UE 104-a) as a “master UE” and provide a non-contention RACH sequence for the first UE 104-a to utilize to access the channel for communications with the network entity. But given the grouping of the UEs, the unique non-contention RACH sequence provided by the gNB to the first UE 104-a may also be utilized by the second UE 104-b and third UE 104-c that are grouped together. To this end, the first UE 104-a may provide scheduling information to the slave UEs (e.g., second UE 104-b and third UE 104-c) to coordinate the time slots that each of the plurality of slave UEs 104 may use the sequence for non-contention access to the network entity. By coordinating the shared use of the same non-contention RACH sequence provided by the network entity to the first UE 104-a (e.g., master UE) with the second UE 104-b and third UE 104-c (e.g., slave UEs) that are grouped together, each of the UEs may reduce the access delay to the channel.

The first UE 104-a (e.g., master UE) may coordinate the scheduling information that includes the non-contention sequence and timing information with the slave UEs (e.g., the second UE 104-b and third UE 104-c) within the group via sidelink control information (SCI) message. In one example, the master UE (e.g., first UE 104-a) may provide periodic time duration (e.g., in slots) as to when each of the slave UEs 104 can use the sequence for non-contention access. For example, if N UEs are grouped together in an association, UE-i may be allocated the sequence during time slots {i mod N}. In some examples, the master UE (e.g., first UE 104-a) may allocate the sequence based on an on-demand requests from the one or more slave UEs (e.g., the second UE 104-b and/or third UE 104-c) that intend to access the channel. The requests to access the channel and assignment of sequences from the one or more slave UEs to the master UE may be provided via SCI, radio resource control (RRC), or higher layer messaging.

In the above example, it would be appreciated that a single UE 104 from the plurality of UEs 104 that are grouped together may perform channel access concurrently at any one time slot. But to enable more flexibility, the network entity may also assign a RACH sequence set (e.g., with more than one sequence) to a group of UEs 104 that are associated together. In such case, more than one UE in the association can concurrently access the channel. Sequence management of which sequence may be used by any particular UE from within the group of a plurality of UEs may be performed by the master UE 104.

In addition or alternative to sharing a RACH sequence, in some examples, the master UE may share a timing advance (TA) among members of the group of a plurality of UEs to improve channel access efficiently. In wireless communications, TA may be used to control the uplink transmission timing of individual UEs 104 to ensure that uplink transmission from the UE are synchronized to be received by the network entity. In some examples, the TA notification may be provided by the network entity to the UE 104 via random access response (RAR). And because the plurality of UEs 104 that are associated together may be in close proximity to each other, for example with reference to FIGS. 7A and 7B, the TAs for each of the other UEs may be similar. Sharing the TA information may enable low latency channel access for the plurality of UEs 104 in the association because the grouped UEs 104 may perform a 2-step (or 4-step) RACH without the possibility of receiving a fallback RAR.

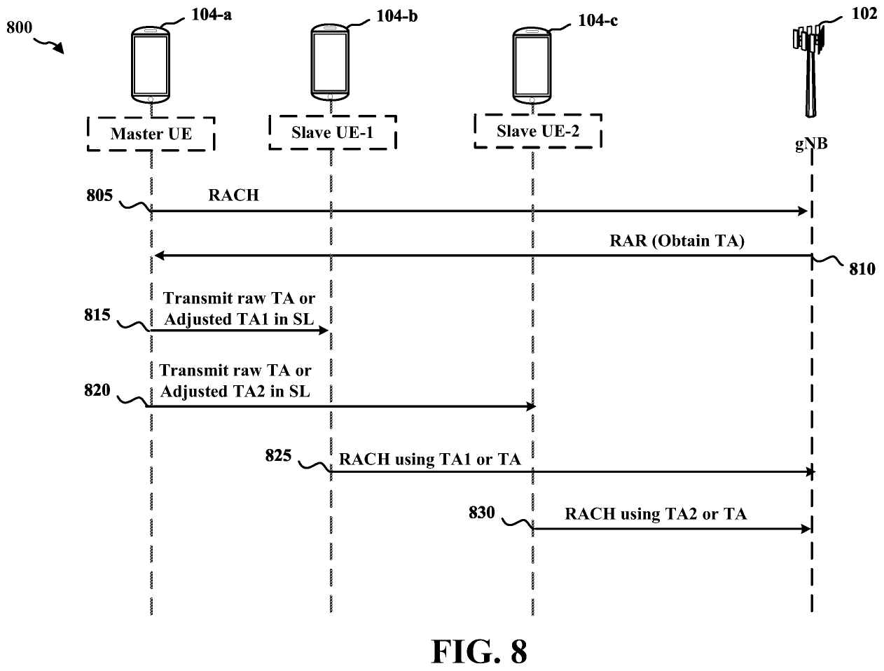

For example, FIG. 8 is a conceptual call flow diagram 800 illustrating the data flow between a plurality UEs 104 that are associated with each other and the network entity (e.g., gNB 102). In the call flow diagram 800, the first UE 104-a may be a master UE, as discussed above, while one or both of second UE 104-b and third UE 104-c may be slave UEs.

At block 805, the first UE 104-a (master UE) may perform RACH using either a 4-step or 2-step RACH process with the network entity 102 (gNB). At block 810, the gNB 102 may transmit a RAR to the first UE 104-a that includes the TA information. At blocks 815 and 820, the first UE 104-a (master UE) may share the TA information with the second UE 104-b (e.g., first slave UE) and the third UE 104-b (e.g., second slave UE), respectively. In some examples, the first UE 104-a (master UE) may transmit the TA information to the second UE 104-b and/or third UE 104-c (slave UEs) as part of broadcast, groupcast, or unicast message using SCI, RRC, or media access control (MAC) control element (CE) message. The first UE 104-a (master UE) may either provide the slave UEs the raw TA (e.g., the TA information received at the master UE from the gNB) or adjusted TA information. The adjusted TA information may be calculated by the first UE 104-a (master UE) based on the relative location of the master UE in relationship to the one or more slave UEs (e.g., second UE 104-b and/or third UE 104-c). Thus, the adjusted TA, in some examples, may be based on the raw TA that the master UE 104 received from the gNB 102 at block 810 adjusted to account for the time delay based on the relative distance of the slave UEs 104 (e.g., second UE 104-b and/or third UE 104-c) from the master UE (e.g., first UE 104-a).

At block 825, the second UE 104-b may perform a 2-step or 4-step RACH based on receiving either the raw or adjusted TA from the master UE (e.g., first UE 104-a) without obtaining fallback RAR. Similarly, at block 830, the third UE 104-c may perform a 2-step or 4-step RACH based on receiving either the raw or adjusted TA from the master UE (e.g., first UE 104-a) without obtaining fallback RAR. Thus, the sharing of the TA information from the master UE with the slave UEs within the group may conserve resources for at least the one or more slave UEs in accessing the channel.

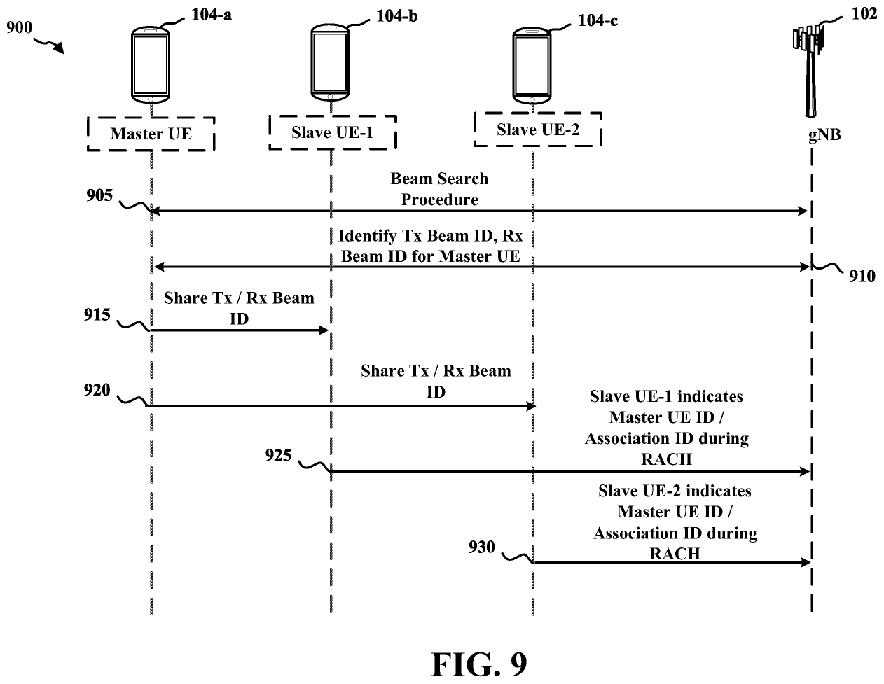

In another example, FIG. 9 is conceptual call flow diagram 900 illustrating another call flow between a plurality UEs 104 that are associated with each other and the network entity (e.g., gNB 102). As above, in the data flow diagram 900, the first UE 104-a may be a master UE while one or both of second UE 104-b and third UE 104-c may be slave UEs.

In some examples, in addition or alternative to the RACH sequence and/or TA information that is shared by the master UE with one or more slave UEs within a group as discussed above, the master UE (e.g., first UE 104-a) may also share information regarding beam search operation with the slave UEs 104. As noted above, the beam search operation may involve a joint process between the gNB 102 and UE 104 to jointly select a Tx/Rx beam for communication. In some aspects, the beam search operation may include a plurality of steps (supra FIGS. 6A-6C).

In some examples, at block 905, the master UE (e.g., first UE 104-a) may complete the beam search operation with the gNB 102 to select a Tx and/or Rx beam for communication that includes each of the P1, P2, and P3 procedures outlined above with reference to FIGS. 6A-6C. At block 910, the master UE (e.g., first UE 104-a) may receive the identity of Tx beam ID and Rx beam ID for the first UE 104-a to utilize for communication with the gNB 102.

At blocks 915 and 920, the master UE (e.g., first UE 104-a) may subsequently provide information related to one or more of the beam search operation (e.g., P1, P2, and/or P3 procedure) or the selected Tx/Rx beams to the one or more slave UEs (e.g., second UE 104-b and/or third UE 104-c). The sharing of the beam search operation information from the master UE with the plurality of slave UEs within the group offers advantages in beam management procedures in that each slave UE 104 (e.g., second UE 104-b and/or third UE 104-c) that subsequently seeks to connect to the network entity may avoid the need to complete an exhaustive beam management procedure. The truncated procedure may result in rapid and accurate beam search and locking procedure for the plurality of slave UEs 104 within the associated UEs.

Thus, in one example, the master UE (e.g., first UE 104-a) may provide the outcome of the P1 procedure completed between the first UE 104-a and the network entity 102 to the one or more slave UEs (e.g., second UE 104-b and/or third UE 104-c). Based on the completed P1 procedures, the slave UEs (e.g., second UE 104-b and/or third UE 104-c) may utilize the shared information regarding the P1 procedure to perform the beam search with the gNB 102 to complete the remaining steps (e.g., P2 and P3), but avoid repeating the initial P1 procedure.

In another example, the master UE (e.g., first UE 104-a) may complete its own beam search operation (e.g., P1, P2, and P3) with the gNB 102. Following the completion of the beam search operation, the master UE (e.g., first UE 104-a) may provide the outcome of the P1 and the P2 procedures completed between the first UE 104-a and the network entity 102 to the one or more slave UEs (e.g., second UE 104-b and/or third UE 104-c). In other words, the master UE (e.g., first UE 104-a) may provide a set of Tx beam identification (IDs) and an Rx beam ID to the one or more slave UEs (e.g., second UE 104-b and/or third UE 104-c). In turn, the one or more slave UEs (e.g., second UE 104-b and/or third UE 104-c) may utilize the received information regarding the set of Tx beam IDs and an Rx beam ID to perform beam search with the gNB 102 (e.g., complete the P3 procedure).

Finally, in some cases, the master UE (e.g., first UE 104-a) after completing the beam search operation (e.g., P1, P2, and P3) with the gNB 102, may provide to the one or more slave UEs (e.g., second UE 104-b and/or third UE 104-c) the unique Tx and/or Rx beam ID that the slave UEs may use to perform communication with the gNB. In such instance, the slave UEs (e.g., second UE 104-b and/or third UE 104-c) may avoid or forego performing any steps associated with beam search operation between the slave UE and the gNB 102. Thus, the one or more slave UEs (e.g., second UE 104-b and/or third UE 104-c) may benefit from the beam search operation performed and completed by the master UEs.

But regardless of whether the one or more slave UEs (e.g., second UE 104-b and/or third UE 104-c) receive partial or completed beam search information (e.g., P1, P2, or P3) from the master UE (e.g., first UE 104-a), the gNB 102 may need to be informed when the subsequent slave UEs attempt to access the channel so that the gNB 102 may resume the beam search procedure from the prior information that the gNB 102 obtained from the master UE (e.g., first UE 104-a) (as opposed to restarting the beam search operation from the first step). Thus, at blocks 925 and 930, the slave UEs (e.g., second UE 104-b and/or third UE 104-c) may respectively message the gNB 102 to inform the gNB 102 that the slave UEs are associated with the master UE (e.g., first UE 104-a).

To this end, the slave UEs (e.g., second UE 104-b and/or third UE 104-c), at block 925 and 930, when performing RACH may indicate the sidelink ID of the master UE (e.g., first UE 104-a) as part of the MSG-A PUSCH for 2-step RACH for the 4-step RACH. Such signaling allows the gNB to be aware that the beam search operation can be initiated based on Tx beam ID that the gNB 102 used for the master UE (e.g., first UE 104-a). Additionally or alternatively, the association of the slave UEs (e.g., second UE 104-b and/or third UE 104-c) with the master UE (e.g., first UE 104-a) may be indicated via associated ID using RRC connection request when the slave UE initiates beam search or performs RACH.

Thus, based on the beam search outcome for the master UE 104-a that the gNB 102 previously performed, the gNB 102 may initiate the beam search for the one or more slave UEs (e.g., second UE 104-b and/or third UE 104-c). That is, the gNB 102 may use the set of Tx beam IDs that was previously identified to be the optional beam for the master UE to subsequently use for transmissions to the slave UE, while the slave UE may utilize the set of Rx beam IDs that was identified as ideal Rx beam for the master UE.

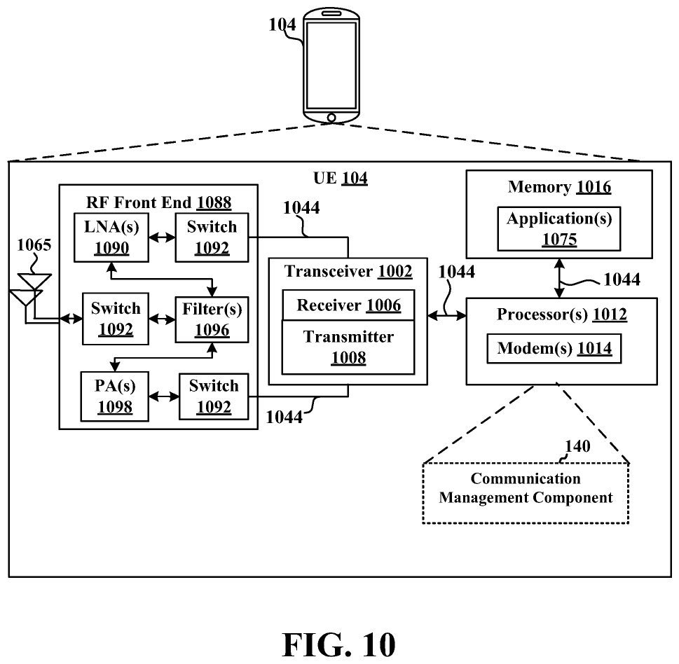

Referring to FIG. 10, one example of an implementation of UE 104 may include a variety of components, some of which have already been described above, but including components such as one or more processors 1012 and memory 1016 and transceiver 1002 in communication via one or more buses 1044, which may operate in conjunction with modem 1014, and communication management component 140 to enable one or more of the functions described herein related to management of RACH and beam search operations for a plurality of UEs that may be grouped or associated together. The UE 104 may be an example of UE 104 described with reference to FIGS. 1, 3, and 4-10 above. Further, the one or more processors 1012, modem 1014, memory 1016, transceiver 1002, RF front end 1088 and one or more antennas 1065 may be configured to support voice and/or data calls (simultaneously or non-simultaneously) in one or more radio access technologies. The antennas 1065 may include one or more antennas, antenna elements, and/or antenna arrays.

In an aspect, the one or more processors 1012 may include a modem 1014 that uses one or more modem processors. The various functions related to communication management component 140 may be included in modem 1014 and/or processors 1012 and, in an aspect, may be executed by a single processor, while in other aspects, different ones of the functions may be executed by a combination of two or more different processors. For example, in an aspect, the one or more processors 1012 may include any one or any combination of a modem processor, or a baseband processor, or a digital signal processor, or a transmit processor, or a receiver processor, or a transceiver processor associated with transceiver 1002. In other aspects, some of the features of the one or more processors 1012 and/or modem 1014 associated with communication management component 140 may be performed by transceiver 1002.

Also, memory 1016 may be configured to store data used herein and/or local versions of applications 1075, communication management component 140 and/or one or more of subcomponents thereof being executed by at least one processor 1012. Memory 1016 may include any type of computer-readable medium usable by a computer or at least one processor 1012, such as random access memory (RAM), read only memory (ROM), tapes, magnetic discs, optical discs, volatile memory, non-volatile memory, and any combination thereof.

Transceiver 1002 may include at least one receiver 1006 and at least one transmitter 1008. Receiver 1006 may include hardware, firmware, and/or software code executable by a processor for receiving data, the code comprising instructions and being stored in a memory (e.g., computer-readable medium). Receiver 1006 may be, for example, a radio frequency (RF) receiver. In an aspect, receiver 1006 may receive signals transmitted by at least one base station 102. Additionally, receiver 1006 may process such received signals, and also may obtain measurements of the signals, such as, but not limited to, Ec/Io, SNR, RSRP, RSSI, etc. Transmitter 1008 may include hardware, firmware, and/or software code executable by a processor for transmitting data, the code comprising instructions and being stored in a memory (e.g., computer-readable medium). A suitable example of transmitter 1008 may including, but is not limited to, an RF transmitter.

Moreover, in an aspect, UE 104 may include RF front end 1088, which may operate in communication with one or more antennas 1065 and transceiver 1002 for receiving and transmitting radio transmissions, for example, wireless communications transmitted by at least one base station 102 or wireless transmissions transmitted by UE 104. RF front end 1088 may be connected to one or more antennas 1065 and may include one or more low-noise amplifiers (LNAs) 1090, one or more switches 1092, one or more power amplifiers (PAs) 1098, and one or more filters 1096 for transmitting and receiving RF signals.

In an aspect, LNA 1090 may amplify a received signal at a desired output level. In an aspect, each LNA 1090 may have a specified minimum and maximum gain values. In an aspect, RF front end 1088 may use one or more switches 1092 to select a particular LNA 1090 and its specified gain value based on a desired gain value for a particular application.

Further, for example, one or more PA(s) 1098 may be used by RF front end 1088 to amplify a signal for an RF output at a desired output power level. In an aspect, each PA 1098 may have specified minimum and maximum gain values. In an aspect, RF front end 1088 may use one or more switches 1092 to select a particular PA 1098 and its specified gain value based on a desired gain value for a particular application.

Also, for example, one or more filters 1096 may be used by RF front end 1088 to filter a received signal to obtain an input RF signal. Similarly, in an aspect, for example, a respective filter 1096 may be used to filter an output from a respective PA 1098 to produce an output signal for transmission. In an aspect, each filter 1096 may be connected to a specific LNA 1090 and/or PA 1098. In an aspect, RF front end 1088 may use one or more switches 1092 to select a transmit or receive path using a specified filter 1196, LNA 1090, and/or PA 1098, based on a configuration as specified by transceiver 1002 and/or processor 1012.

As such, transceiver 1002 may be configured to transmit and receive wireless signals through one or more antennas 1065 via RF front end 1088. In an aspect, transceiver 1002 may be tuned to operate at specified frequencies such that UE 104 can communicate with, for example, one or more base stations 102 or one or more cells associated with one or more base stations 102. In an aspect, for example, modem 1014 may configure transceiver 1002 to operate at a specified frequency and power level based on the UE configuration of the UE 104 and the communication protocol used by modem 1014.

In an aspect, modem 1014 may be a multiband-multimode modem, which can process digital data and communicate with transceiver 1002 such that the digital data is sent and received using transceiver 1002. In an aspect, modem 1014 may be multiband and be configured to support multiple frequency bands for a specific communications protocol. In an aspect, modem 1014 may be multimode and be configured to support multiple operating networks and communications protocols. In an aspect, modem 1014 may control one or more components of UE 104 (e.g., RF front end 1088, transceiver 1002) to enable transmission and/or reception of signals from the network based on a specified modem configuration. In an aspect, the modem configuration may be based on the mode of the modem and the frequency band in use. In another aspect, the modem configuration may be based on UE configuration information associated with UE 104 as provided by the network during cell selection and/or cell reselection.

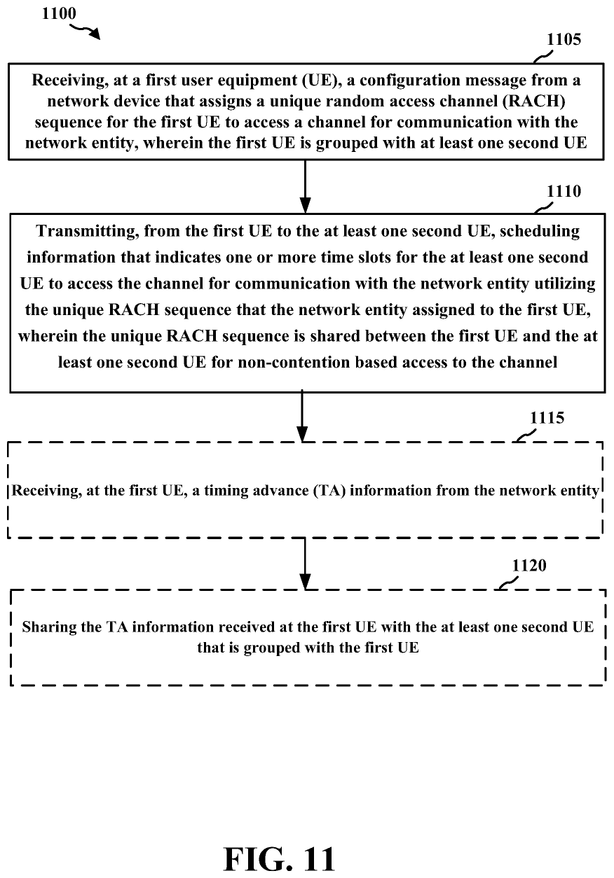

FIG. 11 is a flowchart of a method 1100 of wireless communication that may be performed by a UE (e.g., the UE 104, which may include the memory 360 and which may be the entire UE 104 or a component of the UE 104 such as the communication management component 140, TX processor 368, the RX processor 356, and/or the controller/processor 359). The method 1100 may be performed by the UE 104 including the communication management component 140. The UE 104 may also include components as disclosed with reference to FIG. 10 above.

At block 1105, the method 1100 may include receiving, at a first UE, a configuration message from a network entity that assigns a unique RACH sequence for the first UE to access a channel for communication with the network entity, wherein the first UE is grouped with at least one second UE. The first UE may be grouped with the at least one second UE based on a distance that is less than a proximity threshold. In some examples, the first UE may be identified as a master UE and the at least one second UE may be a slave UE within a plurality of UEs that are grouped together. In some examples, the method 1100 may include receiving, at the first UE, a set of RACH sequences from the network entity to be utilized by a plurality of UEs that are grouped with the first UE, and allocating the unique RACH sequence from a set of RACH sequences to the plurality of UEs grouped with the first UE for accessing the channel to communicate with the network entity, wherein the first UE identifies a time slot and the unique RACH sequence for the at least one second UE to utilize for accessing the channel.

In an aspect, for example, the UE 104, the Rx processor 356, the controller/processor 359, and/or the processor 1112 may execute the communication management component 140 may perform the method 1105. Accordingly, the UE 104, the Rx processor 356, the controller/processor 359, and/or the processor 1112 may execute the communication management component 140 may perform the method 1105 may provide means for receiving, at a first UE, a configuration message from a network entity that assigns a unique RACH sequence for the first UE to access a channel for communication with the network entity.

At block 1110, the method 1100 may include transmitting, from the first UE to the at least one second UE, scheduling information that indicates one or more time slots for the at least one second UE to access the channel for communication with the network entity utilizing the unique RACH sequence that the network entity assigned to the first UE, wherein the unique RACH sequence is shared between the first UE and the at least one second UE for non-contention based access to the channel. In some examples, the scheduling information may be transmitted from the first UE to the at least one second UE in response to an on-demand request received by the first UE from the at least one second UE for access to the channel. The on-demand request is received at the first UE via SCI message or RRC message. In an aspect, for example, the UE 104, the Tx processor 368, the controller/processor 359, and/or the processor 1112 may execute the communication management component 140 may perform the method 1110.

Accordingly, the UE 104, the Tx processor 368, the controller/processor 359, and/or the processor 1112 may execute the communication management component 140 to provide means for transmitting, from the first UE to the at least one second UE, scheduling information that indicates one or more time slots for the at least one second UE to access the channel for communication with the network entity utilizing the unique RACH sequence that the network entity assigned to the first UE.

In some examples, the first UE and the at least one second UE may refrain from performing channel accessing using the unique RACH sequence during an overlapping time period.

At block 1115, the method 1100 may optionally or alternatively include receiving, at the first UE, a timing advance (TA) information from the network entity. In an aspect, for example, the UE 104, the Tx processor 368, the controller/processor 359, and/or the processor 1112 may execute the communication management component 140 may perform the method 1115. Accordingly, the UE 104, the Tx processor 368, the controller/processor 359, and/or the processor 1112 may execute the communication management component 140 to provide means for receiving, at the first UE, a timing advance (TA) information from the network entity.

At block 1120, the method 1100 may optionally or alternatively include sharing the TA information received at the first UE with the at least one second UE that is grouped with the first UE. In some examples, the TA information that is shared by the first UE with the at least one second UE may be unmodified TA information provided by the network entity to the first UE. In other examples, the TA information that is shared by the first UE with the at least one second UE may be an adjusted TA value that is calculated by the first UE based in part on distance from the first UE to the at least one second UE. The TA information that is shared with the at least one second UE may allow the at least one second UE to perform separate RACH procedures using the TA information (e.g., see above FIG. 8, blocks 825 and 830). In some aspects, sharing the TA information from the first UE to the at least one second UE comprises one of a broadcast, groupcast, unicast message using sidelink control information (SCI), media access control (MAC) control element (CE), or radio resource control (RRC) message. In an aspect, for example, the UE 104, the Tx processor 368, the controller/processor 359, and/or the processor 1112 may execute the communication management component 140 may perform the method 1120. Accordingly, the UE 104, the Tx processor 368, the controller/processor 359, and/or the processor 1112 may execute the communication management component 140 to provide means for sharing the TA information received at the first UE with the at least one second UE that is grouped with the first UE.

It should be appreciated by those of ordinary skill that methods of block 1115 and 1120 may not need to be performed after blocks 1105 or 1110. Indeed, the steps of blocks 1115 and 1120 discussed below may be stand-alone steps performed by the UE.

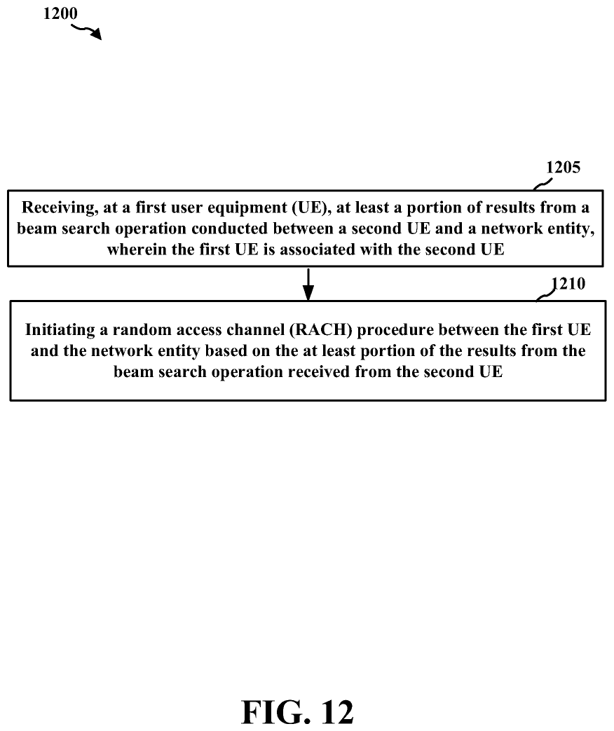

FIG. 12 is a flowchart of a method 1200 of wireless communication that may be performed by a UE (e.g., the UE 104, which may include the memory 360 and which may be the entire UE 104 or a component of the UE 104 such as the communication management component 140, TX processor 368, the RX processor 356, and/or the controller/processor 359) when the UE is operating as a slave UE, as discussed above. The method 1200 may be performed by the UE 104 including the communication management component 140. The UE 104 may also include components as disclosed with reference to FIG. 10 above.

At block 1205, the method 1200 may include receiving, at a first UE, at least a portion of results from a beam search operation conducted between a second UE and a network entity, wherein the first UE is associated with the second UE. In an aspect, for example, the UE 104, the Rx processor 356, the controller/processor 359, and/or the processor 1112 may execute the communication management component 140 may perform the method 1205. Accordingly, the UE 104, the Rx processor 356, the controller/processor 359, and/or the processor 1112 may execute the communication management component 140 may perform the method 1105 may provide means for receiving, at a first UE, at least a portion of results from a beam search operation conducted between a second UE and a network entity.

At block 1210, the method 1200 may include initiating a random access channel (RACH) procedure between the first UE and the network entity based on said at least a portion of results from the beam search operation received from the second UE.

In some examples, said at least a portion of results from the beam search operation conducted between the second UE and the network entity that are received at the first UE may include an outcome of a first step (e.g., P1 step) of the beam search operation. As a result, the first UE may utilize the outcome of the first step of the beam search operation from the second UE to perform a beam search between the first UE and the network entity to complete remaining steps of the beam search operation by foregoing repeating the first step of the beam search operation at the first UE.

In other examples, the at least portion of results from the beam search operation conducted between the second UE and the network entity that are received at the first UE may include a set of transmitter (Tx) beam identifications (IDs) and a receiver (Rx) beam ID information that was selected for communication between the second UE and the network entity. As a result, the first UE may utilize the set of Tx beam IDs and the Rx beam ID information received from the second UE to complete remaining steps of the beam search operation at the first UE.

In yet another example, the at least portion of results from the beam search operation conducted between the second UE and the network entity that are received at the first UE may include a unique transmitter (Tx) beam identification (ID) and a receiver (Rx) beam ID information that was selected for communication between the second UE and the network entity. In such instance, the first UE may utilize the unique Tx beam ID and the Rx beam ID information for communication with the network entity.

In some aspects, initiating the RACH procedure between the first UE and the network entity based on the at least portion of the results from the beam search operation received from the second UE may include providing a sidelink identification (ID) of the second UE to the network entity in order to prevent the first UE or the network entity from restarting the beam search operation from the start.

In an aspect, for example, the UE 104, the Tx processor 368, the controller/processor 359, and/or the processor 1112 may execute the communication management component 140 may perform the method 1210. Accordingly, the UE 104, the Rx processor 356, the controller/processor 359, and/or the processor 1112 may execute the communication management component 140 may perform the method 1105 may provide means for initiating a RACH procedure between the first UE and the network entity based on the at least portion of the results from the beam search operation received from the second UE.

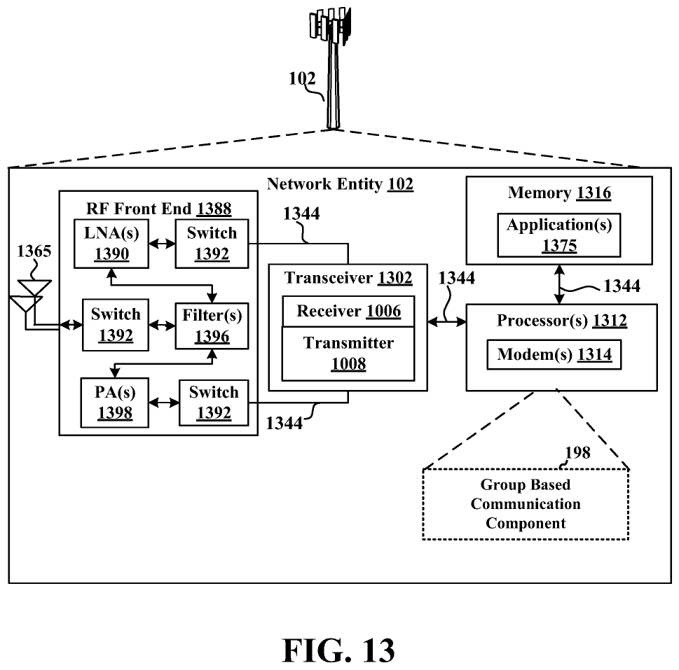

Referring to FIG. 13, one example of an implementation of base station or network entity 102 may include a variety of components, some of which have already been described above, but including components such as one or more processors 1312 and memory 1316 and transceiver 1302 in communication via one or more buses 1344, which may operate in conjunction with modem 1314, and group based communication component 198 to enable one or more of the functions described herein related to management of RACH and beam search operations for a plurality of UEs that may be grouped or associated together. The network entity 102 may be an example of BS or network entity 102 described with reference to FIGS. 1, 3, and 4-10 above. Further, the one or more processors 1312, modem 1314, memory 1316, transceiver 1302, RF front end 1388 and one or more antennas 1365 may be configured to support voice and/or data calls (simultaneously or non-simultaneously) in one or more radio access technologies. The antennas 1065 may include one or more antennas, antenna elements, and/or antenna arrays.

In an aspect, the one or more processors 1312 may include a modem 1314 that uses one or more modem processors. The various functions related to group based communication component 198 may be included in modem 1314 and/or processors 1312 and, in an aspect, may be executed by a single processor, while in other aspects, different ones of the functions may be executed by a combination of two or more different processors. For example, in an aspect, the one or more processors 1312 may include any one or any combination of a modem processor, or a baseband processor, or a digital signal processor, or a transmit processor, or a receiver processor, or a transceiver processor associated with transceiver 1302. In other aspects, some of the features of the one or more processors 1312 and/or modem 1314 associated with communication management component 140 may be performed by transceiver 1302.

Also, memory 1316 may be configured to store data used herein and/or local versions of applications 1375, group based communication component 198 and/or one or more of subcomponents thereof being executed by at least one processor 1312. Memory 1316 may include any type of computer-readable medium usable by a computer or at least one processor 1312, such as random access memory (RAM), read only memory (ROM), tapes, magnetic discs, optical discs, volatile memory, non-volatile memory, and any combination thereof.

Transceiver 1302 may include at least one receiver 1306 and at least one transmitter 1308. Receiver 1306 may include hardware, firmware, and/or software code executable by a processor for receiving data, the code comprising instructions and being stored in a memory (e.g., computer-readable medium). Receiver 1306 may be, for example, a radio frequency (RF) receiver. In an aspect, receiver 1306 may receive signals transmitted by at least one base station 102. Additionally, receiver 1306 may process such received signals, and also may obtain measurements of the signals, such as, but not limited to, Ec/Io, SNR, RSRP, RSSI, etc. Transmitter 1308 may include hardware, firmware, and/or software code executable by a processor for transmitting data, the code comprising instructions and being stored in a memory (e.g., computer-readable medium). A suitable example of transmitter 1308 may including, but is not limited to, an RF transmitter.

Moreover, in an aspect, network entity 102 may include RF front end 1388, which may operate in communication with one or more antennas 1365 and transceiver 1302 for receiving and transmitting radio transmissions, for example, wireless communications transmitted by at least one base station 102 or wireless transmissions transmitted by UE 104. RF front end 1388 may be connected to one or more antennas 1365 and may include one or more low-noise amplifiers (LNAs) 1390, one or more switches 1392, one or more power amplifiers (PAs) 1398, and one or more filters 1396 for transmitting and receiving RF signals.

In an aspect, LNA 1390 may amplify a received signal at a desired output level. In an aspect, each LNA 1390 may have a specified minimum and maximum gain values. In an aspect, RF front end 1388 may use one or more switches 1392 to select a particular LNA 1090 and its specified gain value based on a desired gain value for a particular application.

Further, for example, one or more PA(s) 1398 may be used by RF front end 1388 to amplify a signal for an RF output at a desired output power level. In an aspect, each PA 1398 may have specified minimum and maximum gain values. In an aspect, RF front end 1388 may use one or more switches 1392 to select a particular PA 1398 and its specified gain value based on a desired gain value for a particular application.

Also, for example, one or more filters 1396 may be used by RF front end 1388 to filter a received signal to obtain an input RF signal. Similarly, in an aspect, for example, a respective filter 1396 may be used to filter an output from a respective PA 1398 to produce an output signal for transmission. In an aspect, each filter 1396 may be connected to a specific LNA 1390 and/or PA 1398. In an aspect, RF front end 1088 may use one or more switches 1392 to select a transmit or receive path using a specified filter 1196, LNA 1390, and/or PA 1398, based on a configuration as specified by transceiver 1302 and/or processor 1312.

As such, transceiver 1302 may be configured to transmit and receive wireless signals through one or more antennas 1365 via RF front end 1388. In an aspect, transceiver 1302 may be tuned to operate at specified frequencies such that network entity 102 can communicate with, for example, one or more UEs 104 or one or more additional cells associated with one or more network entities 102. In an aspect, for example, modem 1314 may configure transceiver 1302 to operate at a specified frequency and power level.

In an aspect, modem 1314 may be a multiband-multimode modem, which can process digital data and communicate with transceiver 1302 such that the digital data is sent and received using transceiver 1302. In an aspect, modem 1314 may be multiband and be configured to support multiple frequency bands for a specific communications protocol. In an aspect, modem 1314 may be multimode and be configured to support multiple operating networks and communications protocols. In an aspect, modem 1314 may control one or more components of network entity 102 (e.g., RF front end 1388, transceiver 1302) to enable transmission and/or reception of signals from the network based on a specified modem configuration. In an aspect, the modem configuration may be based on the mode of the modem and the frequency band in use.

The apparatus may include additional components that perform each of the blocks of the algorithm in the aforementioned flowcharts. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

### Some Further Example Clauses

Implementation examples are described in the following numbered clauses:

1. A method for wireless communication, comprising:
receiving, at a first user equipment (UE), a configuration message from a network entity that assigns a unique random access channel (RACH) sequence for the first UE to access a channel for communication with the network entity, wherein the first UE is grouped with at least one second UE; and
transmitting, from the first UE to the at least one second UE, scheduling information that indicates one or more time slots for the at least one second UE to access the channel for communication with the network entity utilizing the unique RACH sequence that the network entity assigned to the first UE, wherein the unique RACH sequence is shared between the first UE and the at least one second UE for non-contention based access to the channel.

2. The method of clause 1, wherein the first UE and the at least one second UE refrain from performing channel accessing using the unique RACH sequence during an overlapping time period.

3. The method of clause 1 or 2, wherein the scheduling information is transmitted from the first UE to the at least one second UE in response to an on-demand request received by the first UE from the at least one second UE for access to the channel.

4. The method of any of the preceding clauses, wherein the on-demand request is received at the first UE via sidelink control information (SCI) message or radio resource control (RRC) message.

5. The method of any of the preceding clauses, wherein the first UE is grouped with the at least one second UE based on a distance that is less than a proximity threshold.

6. The method of any of the preceding clauses, wherein the first UE is identified as a master UE and the at least one second UE is a slave UE within a plurality of UEs that are grouped together.

7. The method of any of the preceding clauses, wherein receiving the configuration message from the network entity that assigns a unique RACH sequence for the first UE further comprises:
receiving, at the first UE, a set of RACH sequences from the network entity to be utilized by a plurality of UEs that are grouped with the first UE; and
allocating the unique RACH sequence from a set of RACH sequences to the plurality of UEs grouped with the first UE for accessing the channel to communicate with the network entity, wherein the first UE identifies a time slot and the unique RACH sequence for the at least one second UE to utilize for accessing the channel.

8. The method of any of the preceding clauses, further comprising:
receiving, at the first UE, a timing advance (TA) information from the network entity; and
sharing the TA information received at the first UE with the at least one second UE that is grouped with the first UE.

9. The method of any of the preceding clauses, wherein the TA information that is shared by the first UE with the at least one second UE is unmodified TA information provided by the network entity to the first UE.

10. The method of any of the preceding clauses, wherein the TA information that is shared by the first UE with the at least one second UE is an adjusted TA value that is calculated by the first UE based in part on distance from the first UE to the at least one second UE.

11. The method of any of the preceding clauses, wherein sharing the TA information from the first UE to the at least one second UE comprises one of a broadcast, groupcast, unicast message using sidelink control information (SCI), media access control (MAC) control element (CE), or radio resource control (RRC) message.

12. An apparatus for wireless communication, comprising:
a memory storing computer-executable instructions; and at least one processor coupled with the memory and configured to execute the computer-executable instructions to:
   receive, at a first user equipment (UE), a configuration message from a network entity that assigns a unique random access channel (RACH) sequence for the first UE to access a channel for communication with the network entity, wherein the first UE is grouped with at least one second UE; and
   transmit, from the first UE to the at least one second UE, scheduling information that indicates one or more time slots for the at least one second UE to access the channel for communication with the network entity utilizing the unique RACH sequence that the network entity assigned to the first UE, wherein the unique RACH sequence is shared between the first UE and the at least one second UE for non-contention based access to the channel.

13. The apparatus of clause 12, wherein the first UE and the at least one second UE refrain from performing channel accessing using the unique RACH sequence during an overlapping time period.

14. The apparatus of clauses 12 or 13, wherein the scheduling information is transmitted from the first UE to the at least one second UE in response to an on-demand request received by the first UE from the at least one second UE for access to the channel.

15. The apparatus of any of the preceding clauses 12-14, wherein the on-demand request is received at the first UE via sidelink control information (SCI) message or radio resource control (RRC) message.

16. The apparatus of any of the preceding clauses 12-15, wherein the first UE is grouped with the at least one second UE based on a distance that is less than a proximity threshold.

17. The apparatus of any of the preceding clauses 12-16, wherein the first UE is identified as a master UE and the at least one second UE is a slave UE within a plurality of UEs that are grouped together.

18. The apparatus of any of the preceding clauses 12-17, wherein the computer-executable instructions to receive the configuration message from the network entity that assigns a unique RACH sequence for the first UE are further executable by the at least one processor to:
receive, at the first UE, a set of RACH sequences from the network entity to be utilized by a plurality of UEs that are grouped with the first UE; and
allocate the unique RACH sequence from a set of RACH sequences to the plurality of UEs grouped with the first UE for accessing the channel to communicate with the network entity, wherein the first UE identifies a time slot and the unique RACH sequence for the at least one second UE to utilize for accessing the channel.

19. The apparatus of any of the preceding clauses 12-18, wherein the computer-readable instructions are further executable by the at least one processor to:
receive, at the first UE, a timing advance (TA) information from the network entity; and
share the TA information received at the first UE with the at least one second UE that is grouped with the first UE.

20. The apparatus of any of the preceding clauses 12-19, wherein the TA information that is shared by the first UE with the at least one second UE is unmodified TA information provided by the network entity to the first UE.

21. The apparatus of any of the preceding clauses 12-20, wherein the TA information that is shared by the first UE with the at least one second UE is an adjusted TA value that is calculated by the first UE based in part on distance from the first UE to the at least one second UE.

22. The apparatus of any of the preceding clauses 12-21, wherein sharing the TA information from the first UE to the at least one second UE comprises one of a broadcast, groupcast, unicast message using sidelink control information (SCI), media access control (MAC) control element (CE), or radio resource control (RRC) message.

23. A method for wireless communications, comprising:
receiving, at a first user equipment (UE), at least a portion of results from a beam search operation conducted between a second UE and a network entity, wherein the first UE is associated with the second UE; and
initiating a random access channel (RACH) procedure between the first UE and the network entity based on the at least portion of the results from the beam search operation received from the second UE.

24. The method of clause 23, wherein the at least portion of results from the beam search operation conducted between the second UE and the network entity that are received at the first UE include an outcome of a first step of the beam search operation, and wherein the first UE utilizes the outcome of the first step of the beam search operation from the second UE to perform a beam search between the first UE and the network entity to complete remaining steps of the beam search operation by foregoing repeating the first step of the beam search operation at the first UE.

25. The method of clauses 23 or 24, wherein the at least portion of results from the beam search operation conducted between the second UE and the network entity that are received at the first UE include a set of transmitter (Tx) beam identifications (IDs) and a receiver (Rx) beam ID information that was selected for communication between the second UE and the network entity, and wherein the first UE utilizes the set of Tx beam IDs and the Rx beam ID information received from the second UE to complete remaining steps of the beam search operation at the first UE.

26. The method of any of the preceding clauses 23-25, wherein the at least portion of results from the beam search operation conducted between the second UE and the network entity that are received at the first UE include a unique transmitter (Tx) beam identification (ID) and a receiver (Rx) beam ID information that was selected for communication between the second UE and the network entity, and wherein the first UE utilizes the unique Tx beam ID and the Rx beam ID information for communication with the network entity.

27. The method of any of the preceding clauses 23-26, wherein initiating the RACH procedure between the first UE and the network entity based on the at least portion of the results from the beam search operation received from the second UE includes providing a sidelink identification (ID) of the second UE to the network entity.

28. An apparatus for wireless communication, comprising:
a memory storing computer-executable instructions; and
at least one processor coupled with the memory and configured to execute the computer-executable instructions to:
   receive, at a first user equipment (UE), at least a portion of results from a beam search operation conducted between a second UE and a network entity, wherein the first UE is associated with the second UE; and
   initiate a random access channel (RACH) procedure between the first UE and the network entity based on the at least portion of the results from the beam search operation received from the second UE.

29. The apparatus of clause 28, wherein the at least portion of results from the beam search operation conducted between the second UE and the network entity that are received at the first UE include an outcome of a first step of the beam search operation, and
wherein the first UE utilizes the outcome of the first step of the beam search operation from the second UE to perform a beam search between the first UE and the network entity to complete remaining steps of the beam search operation by foregoing repeating the first step of the beam search operation at the first UE.

30. The apparatus of clauses 28 or 29, wherein the at least portion of results from the beam search operation conducted between the second UE and the network entity that are received at the first UE include a set of transmitter (Tx) beam identifications (IDs) and a receiver (Rx) beam ID information that was selected for communication between the second UE and the network entity, and
wherein the first UE utilizes the set of Tx beam IDs and the Rx beam ID information received from the second UE to complete remaining steps of the beam search operation at the first UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for wireless communication, comprising:
receiving, at a first user equipment (UE), a configuration message from a network entity that assigns a unique random access channel (RACH) sequence for the first UE to access a channel for communication with the network entity, wherein the first UE is grouped with at least one second UE; and
transmitting, from the first UE to the at least one second UE, scheduling information that indicates one or more time slots for the at least one second UE to access the channel for communication with the network entity utilizing the unique RACH sequence that the network entity assigned to the first UE, wherein the unique RACH sequence is shared between the first UE and the at least one second UE for non-contention based access to the channel.

2. The method of claim 1, wherein the first UE and the at least one second UE refrain from performing channel accessing using the unique RACH sequence during an overlapping time period.

3. The method of claim 1, wherein the scheduling information is transmitted from the first UE to the at least one second UE in response to an on-demand request received by the first UE from the at least one second UE for access to the channel.

4. The method of claim 3, wherein the on-demand request is received at the first UE via sidelink control information (SCI) message or radio resource control (RRC) message.

5. The method of claim 1, wherein the first UE is grouped with the at least one second UE based on a distance that is less than a proximity threshold.

6. The method of claim 1, wherein the first UE is identified as a master UE and the at least one second UE is a slave UE within a plurality of UEs that are grouped together.

7. The method of claim 1, wherein receiving the configuration message from the network entity that assigns a unique RACH sequence for the first UE further comprises:
receiving, at the first UE, a set of RACH sequences from the network entity to be utilized by a plurality of UEs that are grouped with the first UE; and
allocating the unique RACH sequence from a set of RACH sequences to the plurality of UEs grouped with the first UE for accessing the channel to communicate with the network entity, wherein the first UE identifies a time slot and the unique RACH sequence for the at least one second UE to utilize for accessing the channel.

8. The method of claim 1, further comprising:
receiving, at the first UE, timing advance (TA) information from the network entity; and
sharing the TA information received at the first UE with the at least one second UE that is grouped with the first UE.

9. The method of claim 8, wherein the TA information that is shared by the first UE with the at least one second UE is unmodified TA information provided by the network entity to the first UE.

10. The method of claim 8, wherein the TA information that is shared by the first UE with the at least one second UE is an adjusted TA value that is calculated by the first UE based in part on distance from the first UE to the at least one second UE.

11. The method of claim 8, wherein sharing the TA information from the first UE to the at least one second UE comprises one of a broadcast, groupcast, unicast message using sidelink control information (SCI), media access control (MAC) control element (CE), or radio resource control (RRC) message.

12. An apparatus for wireless communication, comprising:
a memory storing computer-executable instructions; and
at least one processor coupled with the memory and configured to execute the computer-executable instructions to:
receive, at a first user equipment (UE), a configuration message from a network entity that assigns a unique random access channel (RACH) sequence for the first UE to access a channel for communication with the network entity, wherein the first UE is grouped with at least one second UE; and
transmit, from the first UE to the at least one second UE, scheduling information that indicates one or more time slots for the at least one second UE to access the channel for communication with the network entity utilizing the unique RACH sequence that the network entity assigned to the first UE, wherein the unique RACH sequence is shared between the first UE and the at least one second UE for non-contention based access to the channel.

13. The apparatus of claim 12, wherein the first UE and the at least one second UE refrain from performing channel accessing using the unique RACH sequence during an overlapping time period.

14. The apparatus of claim 12, wherein the scheduling information is transmitted from the first UE to the at least one second UE in response to an on-demand request received by the first UE from the at least one second UE for access to the channel.

15. The apparatus of claim 14, wherein the on-demand request is received at the first UE via sidelink control information (SCI) message or radio resource control (RRC) message.

16. The apparatus of claim 12, wherein the first UE is grouped with the at least one second UE based on a distance that is less than a proximity threshold.

17. The apparatus of claim 12, wherein the first UE is identified as a master UE and the at least one second UE is a slave UE within a plurality of UEs that are grouped together.

18. The apparatus of claim 12, wherein the computer-executable instructions to receive the configuration message from the network entity that assigns a unique RACH sequence for the first UE are further executable by the at least one processor to:
receive, at the first UE, a set of RACH sequences from the network entity to be utilized by a plurality of UEs that are grouped with the first UE; and
allocate the unique RACH sequence from a set of RACH sequences to the plurality of UEs grouped with the first UE for accessing the channel to communicate with the network entity, wherein the first UE identifies a time slot and the unique RACH sequence for the at least one second UE to utilize for accessing the channel.

19. The apparatus of claim 12, wherein the computer-executable instructions are further executable by the at least one processor to:
receive, at the first UE, a timing advance (TA) information from the network entity; and
share the TA information received at the first UE with the at least one second UE that is grouped with the first UE.

20. The apparatus of claim 19, wherein the TA information that is shared by the first UE with the at least one second UE is unmodified TA information provided by the network entity to the first UE.

21. The apparatus of claim 19, wherein the TA information that is shared by the first UE with the at least one second UE is an adjusted TA value that is calculated by the first UE based in part on distance from the first UE to the at least one second UE.

22. The apparatus of claim 19, wherein sharing the TA information from the first UE to the at least one second UE comprises one of a broadcast, groupcast, unicast message using sidelink control information (SCI), media access control (MAC) control element (CE), or radio resource control (RRC) message.

23. A method for wireless communications, comprising:
receiving, at a first user equipment (UE), at least a portion of results from a beam search operation conducted between a second UE and a network entity, wherein the first UE is associated with the second UE; and
initiating a random access channel (RACH) procedure between the first UE and the network entity based on said at least a portion of results from the beam search operation received from the second UE.

24. The method of claim 23, wherein said at least a portion of results from the beam search operation conducted between the second UE and the network entity that are received at the first UE include an outcome of a first step of the beam search operation, and
wherein the first UE utilizes the outcome of the first step of the beam search operation from the second UE to perform a beam search between the first UE and the network entity to complete remaining steps of the beam search operation by foregoing repeating the first step of the beam search operation at the first UE.

25. The method of claim 23, wherein said at least a portion of results from the beam search operation conducted between the second UE and the network entity that are received at the first UE include a set of transmitter (Tx) beam identifications (IDs) and a receiver (Rx) beam ID information that was selected for communication between the second UE and the network entity, and
wherein the first UE utilizes the set of Tx beam IDs and the Rx beam ID information received from the second UE to complete remaining steps of the beam search operation at the first UE.

26. The method of claim 23, wherein said at least a portion of results from the beam search operation conducted between the second UE and the network entity that are received at the first UE include a unique transmitter (Tx) beam identification (ID) and a receiver (Rx) beam ID information that was selected for communication between the second UE and the network entity, and
wherein the first UE utilizes the unique Tx beam ID and the Rx beam ID information for communication with the network entity.

27. The method of claim 23, wherein initiating the RACH procedure between the first UE and the network entity based on said at least a portion of results from the beam search operation received from the second UE includes providing a sidelink identification (ID) of the second UE to the network entity.

28. An apparatus for wireless communication, comprising:
a memory storing computer-executable instructions; and
at least one processor coupled with the memory and configured to execute the computer-executable instructions to:
receive, at a first user equipment (UE), at least a portion of results from a beam search operation conducted between a second UE and a network entity, wherein the first UE is associated with the second UE; and
initiate a random access channel (RACH) procedure between the first UE and the network entity based on said at least a portion of results from the beam search operation received from the second UE.

29. The apparatus of claim 28, wherein said at least a portion of results from the beam search operation conducted between the second UE and the network entity that are received at the first UE include an outcome of a first step of the beam search operation, and
wherein the first UE utilizes the outcome of the first step of the beam search operation from the second UE to perform a beam search between the first UE and the network entity to complete remaining steps of the beam search operation by foregoing repeating the first step of the beam search operation at the first UE.

30. The apparatus of claim 28, wherein said at least a portion of results from the beam search operation conducted between the second UE and the network entity that are received at the first UE include a set of transmitter (Tx) beam identifications (IDs) and a receiver (Rx) beam ID information that was selected for communication between the second UE and the network entity, and
wherein the first UE utilizes the set of Tx beam IDs and the Rx beam ID information received from the second UE to complete remaining steps of the beam search operation at the first UE.
